(19) United States
(12) Patent Application Publication
(10) Pub. No.: US 2016/0236443 A1
(43) Pub. Date: Aug. 18, 2016

(54) OPTICALLY TRANSPARENT COMPOSITE FILM FOR DISPLAY AND MANUFACTURING METHOD THEREFOR

(71) Applicant: ICOMPONENTS CO., LTD., Gyeonggi-do (KR)

(72) Inventors: Hee-Nam HWANG, Gyeonggi-do (KR); Yong-Ho PARK, Gyeonggi-do (KR); Sang-Sik YOON, Gyeonggi-do (KR); Se-Won KIM, Incheon (KR); Ki-Ho LEE, Gyeonggi-do (KR); Mi-Sook NAM, Daejeon (KR)

(21) Appl. No.: 14/892,644

(22) PCT Filed: Oct. 8, 2013
(86) PCT No.: PCT/KR2013/009011

§ 371 Date: Nov. 20, 2015

(30) Foreign Application Priority Data
Aug. 20, 2013 (KR) 10-2013-0098738

(51) Int. Cl. B32B 9/04

(52) U.S. Cl. CPC B32B 9/045; B32B 2264/102; B32B 2457/20; B32B 2307/412; B32B 2307/7244; B32B 2307/7246

(57) ABSTRACT

The present invention relates to an optically transparent composite film for a display, comprising: a polymer substrate containing a transparent thermoplastic base resin; a plasma surface treatment layer formed on one surface of the polymer substrate and surface-modified through plasma treatment; an inorganic gas barrier layer formed on the upper surface of the plasma surface treatment layer; an organic-inorganic hybrid overcoating layer formed on the upper surface of the inorganic gas barrier layer and including a curable product of a curable sol solution; and an inorganic rear layer formed on the other surface of the polymer substrate.

### FIELD

The present disclosure relates to an optically transparent composite film for a display, a manufacturing method therefor, and a flexible display product comprising the same. More particularly, the present disclosure relates to an optically transparent composite film for a display with enhanced gas barrier properties and improved efficiency in the applications as display products, a manufacturing method therefor, and a flexible display product comprising the same.

### BACKGROUND

The present application claims priority to Korean Patent Application No. 10-2013-0098738 filed in the Republic of Korea on Aug. 20, 2013, the disclosures of which are incorporated herein by reference.

In the modern industries, the display industry is confronted with a grave crisis due to overload of supply along with global economic stagnation, and to resolve this crisis, innovative technologies or products are now in emergent need.

A flexible display allows for low-power, low-cost, ultralight and large-scale implementation and is easy to carry with and readily accessible to information anytime and anywhere, and is thus a core technology industry worth gaining attention of ordinary customers. Also, because it allows the application of a roll-to-roll production technique, a flexible display using a polymer film as a substrate is expected to become a leading industry in the display market with the commercialization of mass production technology, mainly, for small-sized home appliances such as mobile appliances.

Particularly, a flexible substrate has been studied as an interesting subject by many companies and research institutes. A glass used in a conventional flexible substrate has good transparency, but according to its characteristics, lacks shock resistance and is thus easily fragile, which becomes a limiting factor for thickness reduction, and due to a large volume per unit weight, the application as a flexible substrate was difficult. As a substitute, a transparent film made from polymer is available, and because polymer is light, thin and flexible, the issues concerning shock resistance, light weight and reduced thickness may be resolved and the application as a flexible substrate is facilitated, the polymer including, for example, thermoplastic polymer with good optical properties such as polycarbonate (PC), polyimide (PI), polyethersulfone (PES), polyarylate (PAR), poly(ethylene naphthalate), poly(ethylene terephthalate) (PET) and cycloolefin copolymer, or polymer obtained by curing a curable resin such as acrylic resin, epoxy resin, or unsaturated polyester.

However, to play a role as a substrate used in a flexible display product, a film made from the exemplary polymers needs enough good characteristics to faithfully play a role as a display, including good oxygen barrier properties and good oxygen barrier properties that directly influence a lifespan of a display. However, because in practice, a polymer transparent film is very poor at moisture and oxygen barrier capability, experiments are being actively conducted to achieve the foregoing properties by forming a multi-layer functional coating layer.

Currently, a multilayer coating including an inorganic gas barrier layer for improving moisture and oxygen barrier properties and an organic-inorganic hybrid coating layer for enhancing barrier properties and imparting good surface hardness is being basically used. Also, studies or inventions are being made to solve the problems by using a method which reduces the surface roughness of a polymer film to stably coat an inorganic gas barrier layer, or adds an undercoating layer to minimize the resistance at the interface between coating layers to improve the adhesion between the layers.

However, the addition of an undercoating layer has an economical disadvantage caused by an additional process operation and inefficiency in the mass production aspect. Also, after manufactured, an optically transparent composite film for a display with good gas barrier properties is attached to a display device using an adhesive suitable for use in the device, and generally, because a surface in contact with the device has very low surface energy, good adhesion is not accomplished, resulting in limited applications in the display industry.

Therefore, to use a polymer transparent film as a flexible display substrate, there is a need for an optically transparent composite film for a display not only with sufficiently enhanced gas barrier properties including moisture barrier properties and oxygen barrier properties, but also with improved adhesive strength with an inorganic gas barrier layer without an undercoating layer, and simultaneously with improved adhesive strength for adhesion to a display device.

### DISCLOSURE

### Technical Problem

The present disclosure is designed to solve the above problems, and therefore, the present disclosure is directed to providing an optically transparent composite film for a display not only with sufficiently enhanced gas barrier properties including moisture barrier properties and oxygen barrier properties but also with improved adhesion with an inorganic gas barrier layer and improved adhesive strength of a surface in contact with a device.

Also, the present disclosure is directed to providing a method of manufacturing the optically transparent composite film for a display and a flexible display product comprising the optically transparent composite film.

### Technical Solution

To achieve the above objects, according to one aspect of the present disclosure, there is provided an optically transparent composite film for a display including a polymer substrate containing a transparent thermoplastic base resin, a plasma surface treatment layer formed on one surface of the polymer substrate and surface-modified by plasma treatment, an inorganic gas barrier layer formed on an upper surface of the plasma surface treatment layer, an organic-inorganic hybrid overcoating layer formed on an upper surface of the inorganic gas barrier layer, and including a resulting cured product of a curable sol solution, the curable sol solution being a mixture of a curable coating solution and a sol solution, the curable coating solution including a (meth)acrylate monomer, a (meth)acrylate oligomer with an epoxy group having a weight average molecular weight of 500-10,000, an initiator, silica particles, and a dispersant, the sol solution including metal alkoxide, a curing accelerator, inorganic acid, and a solvent, and an inorganic rear layer formed on the other surface of the polymer substrate.

According to an exemplary embodiment of the present disclosure, the optically transparent composite film for a display may have an oxygen transmission rate less than or equal to 0.2 cc/m²/day/atm and a vapor transmission rate less than or equal to 0.01 g/m²/day.

According to another exemplary embodiment of the present disclosure, the plasma surface treatment layer may have surface roughness (Ra) less than or equal to 0.3 nm. Also, the plasma surface treatment layer may be obtained by performing plasma treatment on one surface of the polymer substrate, and the plasma treatment may be performed by maintaining a degree of vacuum within a chamber in a range between 0.1 mtorr and 500 mtorr with reactive gas being fed into a plasma treatment zone, and applying plasma power from 0.1 W/cm² to 5 W/cm² and a line speed from 0.1 M/min to 5 M/min.

According to another exemplary embodiment of the present disclosure, the inorganic rear layer may include oxide, nitride, carbide, oxynitride, oxycarbide, carbonitride, or oxycarbonitride containing at least one type of metal selected from the group consisting of Si, Al, In, Sn, Zn, Ti, Cu, Ce and Ta. Also, the inorganic rear layer may have a thickness from 1 nm to 50 nm, and the inorganic rear layer may have surface energy higher than or equal to 50 mJ/m².

According to an exemplary embodiment of the present disclosure, the transparent thermoplastic base resin may be any one selected from the group consisting of polyethersulfone, polycarbonate, polyimide, polyarylate, polyethyleneterephthalate, polyethylenenaphthalate, polyethyleneterephthalateglycol, polycyclohexylenedimethyleneterephthalateglycol, and cycloolefin copolymer, or mixtures thereof.

According to another exemplary embodiment of the present disclosure, the inorganic gas barrier layer may include oxide, nitride, carbide, oxynitride, oxycarbide, carbonitride, or oxycarbonitride containing at least one type of metal selected from the group consisting of Si, Al, In, Sn, Zn, Ti, Cu, Ce and Ta, and the inorganic gas barrier layer may have a thickness from 20 nm to 500 nm.

According to another exemplary embodiment of the present disclosure, a weight ratio of the (meth)acrylate monomer, the (meth)acrylate oligomer with an epoxy group having a weight average molecular weight of 500-10,000, and the silica particles included in the curable coating solution may be 1˜40:1˜40:1˜25, and the metal alkoxide included in the sol solution may be any one selected from metal alkoxide represented by the following chemical formulas 1 through 3, or mixtures thereof:

R¹ₓM¹(OR²)₄₋ₓ [Chemical formula 1]

R¹_{y}M²(OR²)_{3-y} [Chemical formula 2]

R¹_{z}Nb(OR²)_{5-z} [Chemical formula 3]

where R¹ denotes any one selected from the group consisting of an alkyl group having 1 to 4 carbon atoms, a vinyl group, an allyl group, a (meth)acryloxy group, an epoxide group and an amino group, R² denotes an alkyl group having 1 to 4 carbon atoms, M¹ denotes a metal selected from the group consisting of Si, Ti, Zr, Ge and Sn, and M² denotes a metal selected from the group consisting of Al, In and Sb, in which x represents 0, 1, 2 or 3, y represents 0, 1 or 2, and z represents 0, 1, 2, 3 or 4.

According to another exemplary embodiment of the present disclosure, the curing accelerator included in the sol solution may be any one selected from acetic anhydride, acrylic anhydride, cyclic anhydride, hexahydrophthalic anhydride, methacrylic anhydride, propionic anhydride, acetic acid, acrylic acid, formic acid, fumaric acid, itaconic acid, maleic acid, methacrylic acid, propionic acid, and methylenesuccinic acid, or mixtures thereof.

According to another exemplary embodiment of the present disclosure, the hybrid overcoating layer may have a thickness from 0.1 μm to 10 μm.

According to another aspect of the present disclosure, there is provided a method of manufacturing an optically transparent composite film including preparing a polymer substrate containing a transparent thermoplastic base resin, forming a plasma surface treatment layer surface-modified by performing plasma treatment on one surface of the polymer substrate, forming an inorganic gas barrier layer on an upper surface of the plasma surface treatment layer, forming an organic-inorganic hybrid overcoating layer by applying a curable sol solution onto an upper surface of the inorganic gas barrier layer and curing the applied curable sol solution, the curable sol solution prepared by mixing a curable coating solution and a sol solution, the curable coating solution in which a (meth)acrylate monomer, a (meth)acrylate oligomer with an epoxy group having a weight average molecular weight of 500-10,000, and an initiator are dissolved in a dispersant and silica particles are dispersed therein, the sol solution in which metal alkoxide, a curing accelerator, inorganic acid, and water are dissolved in a solvent, and forming an inorganic rear layer on a surface opposite to the gas barrier layer.

According to an exemplary embodiment of the present disclosure, the forming of the plasma surface treatment layer may include maintaining a degree of vacuum within a chamber in a range between 0.1 mtorr and 500 mtorr with reactive gas being fed into a plasma treatment zone, and applying plasma power from 0.1 W/cm² to 5 W/cm² and a line speed from 0.1 M/min to 5 M/min.

According to still another aspect of the present disclosure, there is provided a flexible display product including an optically transparent composite film for a display according to the present disclosure.

### Advantageous Effects

The optically transparent composite film for a display according to the present disclosure enables surface smoothness and surface modification through plasma treatment without an undercoating layer, and may enhance the gas barrier properties including moisture barrier properties and oxygen barrier properties.

In addition, the optically transparent composite film for a display may improve the adhesion with an inorganic gas barrier layer and the adhesive strength of a contact surface in contact with a device.

The application as a flexible display may be made easier through the optically transparent composite film for a display according to the present disclosure.

### BRIEF DESCRIPTION OF THE DRAWINGS

The accompanying drawings illustrate a preferred embodiment of the present disclosure and together with the foregoing disclosure, serve to provide further understanding of the technical spirit of the present disclosure, and thus, the present disclosure is not construed as being limited to the drawings.

FIG. 1 is a cross-sectional view of an optically transparent composite film for a display according to Example 1 of the present disclosure.

FIG. 2 is a cross-sectional view of an optically transparent composite film for a display with no inorganic rear layer according to Comparative example 2.

FIG. 3 is a cross-sectional view of an optically transparent composite film for a display without plasma treatment according to Comparative example 3.

FIG. 4 is a diagram illustrating a roll-to-roll sputter dual-mode tool for forming an optically transparent composite film for a display according to the present disclosure including a plasma treatment zone and six coating zones.

FIG. 5 is a surface image result of a polymer substrate with plasma treatment according to Example 2 of the present disclosure.

FIG. 6 is a surface image result of a polymer substrate without plasma treatment according to Comparative example 4.

Description of reference numerals

| | |
|---|---|
| 100: polymer substrate | 110: plasma surface treatment layer |
| 120: inorganic gas barrier layer | |

130: organic-inorganic hybrid overcoating layer

| | |
|---|---|
| 140: inorganic rear layer | 240: coating drum |
| 241: plasma treatment zone | 242: first coating zone |
| 243: second coating zone | 244: third coating zone |
| 245: fourth coating zone | 246: fifth coating zone |
| 247: sixth coating zone | 248: guide roll |
| 249: unwinder | 250: rewinder |

### MODE FOR CARRYING OUT THE INVENTION

Hereinafter, the present disclosure will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation.

Therefore, the description proposed herein is just a preferable example for the purpose of illustrations only, not intended to limit the scope of the disclosure, so it should be understood that there may be a variety of equivalents and modifications which can replace these embodiments at the time of filing this application.

An optically transparent composite film for a display according to one aspect of the present disclosure includes a polymer substrate containing a transparent thermoplastic base resin; a plasma surface treatment layer formed on one surface of the polymer substrate and surface-modified by plasma treatment; an inorganic gas barrier layer formed on an upper surface of the plasma surface treatment layer; an organic-inorganic hybrid overcoating layer formed on an upper surface of the inorganic gas barrier layer and including a resulting cured product of a curable sol solution, the curable sol solution being a mixture of a curable coating solution and a sol solution, the curable coating solution in which a (meth)acrylate monomer, a (meth)acrylate oligomer with an epoxy group having a weight average molecular weight of 500-10,000, and an initiator are dissolved in a solvent and silica particles are dispersed therein, the sol solution in which metal alkoxide, a curing accelerator, inorganic acid, and water are dissolved in a solvent; and an inorganic rear layer formed on the other surface of the polymer substrate.

The inventors of the present invention found out that to ensure gas barrier properties including moisture barrier properties and oxygen barrier properties necessary to use a transparent polymer film as a display substrate and improve the adhesion with an inorganic gas barrier layer, may have such properties may be obtained through particular plasma treatment of a polymer substrate without adding other coating layer, and along with this, made a surprising discovery about improved adhesive strength between a device and an optically transparent composite film for a display by forming a proper level of an inorganic rear layer on a contact surface with the device, and through these findings, devised the present invention.

The polymer substrate includes transparent thermoplastic base resin, and in this instance, the transparent thermoplastic base resin may include, but is not limited to, polyethersulfone, polycarbonate, polyimide, polyarylate, polyethyleneterephthalate, polyethylenenaphthalate, polyethyleneterephthalateglycol, polycyclohexylenedimethyleneterephthalateglycol, and cycloolefin copolymer.

Generally, various types of impurities are present on the surface of the polymer substrate, and many defects occur when forming an inorganic layer and thus there is a concern that gas barrier properties will greatly deteriorate. Therefore, studies or inventions are being made to solve the problems by using a method which reduces the surface roughness of a polymer film to stably coat an inorganic gas barrier layer, or adds an undercoating layer to minimize the resistance at the interface between coating layers to improve the adhesion between the layers. However, to implement an undercoating layer, a wet process is indispensably performed at least once, resulting in reduced procedural efficiency, which is problematic in the mass production and may bring about a result causing an economical disadvantage. Thus, the present disclosure eliminates a process of forming an undercoating, and prior to a deposition process of an inorganic gas barrier layer, performs plasma treatment in a one-pot process to remove impurities on the surface and improve the surface smoothness. The plasma treatment leads to unexpected improvement effect of adhesion and gas barrier properties including moisture barrier properties and oxygen barrier properties.

As described above, the optically transparent composite film according to one aspect of the present disclosure performs plasma treatment on one surface of the polymer substrate and thereby includes the plasma surface treatment layer formed on one surface of the polymer substrate. In the plasma surface treatment, a degree of vacuum in a chamber is preferably from 0.1 mtorr to 500 mtorr, more preferably from 0.5 mtorr to 100 mtorr, more particularly preferably from 1 mtorr to 10 mtorr. Also, the plasma power is from 0.1 W/cm² to 5 W/cm², preferably from 0.3 W/cm² to 3 W/cm², more preferably from 0.5 W/cm² to 1 W/cm², and a line speed is from 0.1 M/min to 5 M/min. When the degree of vacuum, the plasma power, and the line speed are out of the above ranges, the gas barrier effect and the adhesion with the inorganic barrier layer is not sufficiently obtained, and more specifically, when the degree of vacuum or the plasma power is too high or the line speed is too slow, the surface roughness of the substrate may rather increase during the process. Also, when the degree of vacuum or the plasma power is too low or the line speed is too high, the surface impurities may not be properly removed and modification may not be perfectly accomplished. Here, when determining the degree of vacuum, the plasma power, and the line speed, alteration or modification may be made within the range based on the type or condition of the substrate.

Also, in the plasma treatment, reactive gas such as O₂, Ar, N₂, and H₂ is introduced, and the reactive gas is not limited to a particular type if it generates a plasma.

After the plasma treatment, 80% or more of the impurities present on the surface, preferably 90% or more, more preferably 95% or more should be 10 nm or less in size, preferably 5 nm or less, more preferably 2 nm or less, and the surface roughness, i.e., a Ra value should be 0.3 nm or less, preferably 0.1 nm or less. The lower surface roughness is advantageous to the present disclosure. To reduce the surface roughness, it is important to control the plasma treatment condition, and the plasma treatment condition represents a particular treatment condition, not an extreme condition. When the surface roughness range is satisfied, the gas barrier effect and the adhesion with the inorganic barrier layer according to the present disclosure may be satisfied. In this instance, the impurities refer to organic dust present on the plasma surface treatment layer, and may be adhered onto the film surface in a manufacturing process of the film or a protection film lamination and removal process. The surface roughness and the size of the impurities present on the surface are a value measured using VEECO Dimension 3100 Atomic Force Microscope (AFM).

Also, the inorganic gas barrier layer includes oxide, nitride, carbide, oxynitride, oxycarbide, carbonitride, or oxycarbonitride containing at least one type of metal selected from the group consisting of Si, Al, In, Sn, Zn, Ti, Cu, Ce and Ta. Specifically, the inorganic gas barrier layer may include silicon oxide, silicon nitride, aluminum oxide or indium tin oxide (ITO).

The inorganic gas barrier layer may have a thickness, for example, from 20 nm to 500 nm, or from 30 nm to 100 nm, and when the thickness of the inorganic gas barrier layer satisfies the above range, a uniform film may be formed, good dispersion may be enabled, good gas barrier properties are achieved, a stress reduction effect between layers by virtue of the coating layer may be sufficiently obtained and a problem with cracking or peeling may be prevented.

Subsequently, an organic-inorganic hybrid overcoating layer is formed by performing UV cure or thermal cure of a curable sol solution in which a curable solution and a sol solution are mixed.

The curable sol solution includes a curable coating solution in which a (meth)acrylate monomer, a (meth)acrylate oligomer with an epoxy group having a weight average molecular weight of 500-10,000, and an initiator are dissolved in a dispersant and silica particles are dispersed therein.

The (meth)acrylate monomer acts to control the viscosity and the curing density of the curable coating solution, and improve the adhesion with the inorganic gas barrier layer. The (meth)acrylate monomer may be a monofunctional or multifunctional monomer. Also, the (meth)acrylate monomer may be ethoxylated or propoxylated. The (meth)acrylate monomer may include 2(2-ethoxyethoxy)ethylacrylate, 2-phenoxyethylacrylate, 2-phenoxyethylmethacrylate, caprolactoneacrylate, dicyclopentadienylmethacrylate, tetrahydrofurfurylacrylate, tetrahydrofurfurylmethacrylate, 1,3-butyleneglycoldiacrylate, 1,4 butanedioldimethacrylate, diethyleneglycoldiacrylate, ethoxylated bisphenol A diacrylate, ethoxylated bisphenol A dimethacrylate, ethyleneglycoldimethacrylate, ethoxylated trimethylolpropanetriacrylate, pentaerythritol triacrylate, propoxylated glyceryltriacrylate, propoxylated tri methylolpropanetriacrylate, tri methylolpropanetriacrylate, tri methylolpropanetrimethacrylate, and tris(2-hydroxyethyl) isocyanuratetriacrylate, singularly or in combination.

The (meth)acrylate oligomer with an epoxy group having a weight average molecular weight of 500-10,000 is oligomer having a (meth)acrylate group and an epoxy group, and contributes to favorable attachment of the organic-inorganic hybrid overcoating layer to the plastic transparent film and the inorganic gas barrier layer. Particularly, it contributes to improvement in the adhesion with the plastic transparent film, and may include, for example, a bisphenol-A epoxy acrylate oligomer, a flame retardant epoxy acrylate oligomer, a novolac type epoxy acrylate oligomer, a bisphenol-F epoxy acrylate oligomer, a glycidyl amine type epoxy acrylate oligomer, and a rubber modified epoxy acrylate oligomer, singularly or in combination.

The initiator may be an arbitrary chemical compound able to initiate a polymerization reaction of a (meth)acrylate functional group with actinic rays. Examples of available photoinitiators include 1-hydroxy-cyclohexyl-phenyl-ketone, benzophenone, 2-hydroxy-2-methyl-1-phenyl-1-propanone, 2-hydroxy-1-[4-(2-hydroxyethoxy)phenyl]-2-methyl-1-propanone, 2-benzyl-2-(dimethylamino)-1-[4-(4-morpholinyl)phenyl]-1-butanone, diphenyl(2,4,6-trimethylbenzoyl)-phosphineoxide, and mixtures thereof. A photolatent base-type photoinitiator, for example, 2-methyl-1-[4-(methylthio)phenyl]-2-(4-morpholinyl)-1-propanone may be also used as the photoinitiator.

The dispersant used in the curable coating solution includes methanol, ethanol, propanol, isopropanol, butanol, isobutanol, sec-butanol, tert-butanol, cyclohexanol, pentanol, octanol, decanol, di-n-butylether, ethyleneglycoldimethylether, propyleneglycoldimethylether, propyleneglycolmethylether, dipropyleneglycolmethylether, tripropyleneglycolmethylether, dipropyleneglycoldimethylether, tripropyleneglycoldimethylether, ethyleneglycolbutylether, diethyleneglycolbutylether, ethyleneglycoldibutylether, ethyleneglycolmethylether, diethyleneglycolethylether, diethyleneglycoldimethylether, ethyleneglycolethylether, ethyleneglycoldiethylether, ethyleneglycol, diethyleneglycol, triethyleneglycol, propyleneglycol, dipropyleneglycol, tripropyleneglycol, butyleneglycol, dibutyleneglycol, tributyleneglycol, tetrahydrofuran, dioxane, acetone, diacetonealcohol, methylethylketone, cyclohexanone, methylisobutylketone, ethylacetate, n-propylacetate, n-butylacetate, t-butylacetate, propyleneglycolmonomethyletheracetate, dipropyleneglycolmethyletheracetate, 1-methoxy-2-propanol, ethyl 3-ethoxypropionate, 2-propoxyethanol, ethyleneglycolethyletheracetate, or mixtures thereof.

The silica particles dispersed in the curable coating solution preferably have an average particle size less than or equal to about 100 nm, more preferably less than or equal to about 50 nm. The silica particles may be added to the coating solution, in the form of dry powder or a colloidal matter in a suitable liquid or in other forms. The silica particles may include intact silica particles or silica particles subjected to chemical modification, for example, introduction of a suitable functional group onto the surface, to increase the miscibility of the particles in the curable coating solution.

Also, the curable coating solution may further include silicon alkoxide with a (meth)acrylate group. In the specification, the (meth)acrylate refers to acrylate or methacrylate.

The silicon alkoxide with a (meth)acrylate group may include, for example, (3-acryloxypropyl)dimethylmethoxysilane, (3-acryloxypropyl)methyldimethoxysilane, (3-acryloxypropyl)tri methoxysilane, (methacryloxymethyl)dimethylethoxysilane, methacryloxymethyltriethoxysilane, methacryloxymethyltrimethoxysilane, methacryloxypropylmethyldiethoxysilane, methacryloxypropylmethyldimethoxysilane, (3-methacryloxypropyl)triethoxysilane, and (3-methacryloxypropyl)trimethoxysilane, singularly or in combination.

A relative amount of the respective constituent ingredients of the curable coating solution for forming the organic-inorganic hybrid overcoating layer may be controlled based on desired properties of the film for the substrate, and a weight ratio of the (meth)acrylate monomer, the (meth)acrylate oligomer with an epoxy group having a weight average molecular weight of 500-10,000, and the silica particles included in the curable coating solution is 1˜40:1˜40:1˜25, preferably 10˜30:10˜30:1˜10, or more preferably 15˜25:15˜25:1˜7.

Subsequently, a process of mixing a sol solution with the curable coating solution is performed, the sol solution in which metal alkoxide, a curing accelerator, inorganic acid and water are dissolved in a solvent.

The metal alkoxide included in the sol solution preferably includes any one selected from metal alkoxide represented by the following chemical formulas 1 through 3, or mixtures thereof.

R¹ₓM¹(OR²)₄₋ₓ [Chemical formula 1]

R¹_{y}M²(OR²)_{3-y} [Chemical formula 2]

R¹_{z}Nb(OR²)5_{-z} [Chemical formula 3]

In the chemical formulas 1 through 3, R¹ denotes any one selected from the group consisting of an alkyl group having 1 to 4 carbon atoms, a vinyl group, an allyl group, a (meth)acryloxy group, an epoxide group and an amino group, R² denotes an alkyl group having 1 to 4 carbon atoms, M¹ denotes a metal selected from the group consisting of Si, Ti, Zr, Ge and Sn, and M² denotes a metal selected from the group consisting of Al, In and Sb, in which x represents 0, 1, 2 or 3, y represents 0, 1 or 2, and z represents 0, 1, 2, 3 or 4.

The metal alkoxide may include, for example, aluminumacrylate, aluminumethoxide, aluminumisopropoxide, aluminummethacrylate, antimony III n-butoxide, antimon III ethoxide, antimony III methoxide, germanium n-butoxide, germanium ethoxide, germanium isopropoxide, germanium methoxide, methacryloxytriethylgermanium, indiummethoxy ethoxide, niobium V n-butoxide, niobium V ethoxide, tin II ethoxide, tin II methoxide, di-n-butyldiacrylatetin di-n-butyldimethacrylatetin, titanium n-butoxide, titanium ethoxide, titaniumisobutoxide, titaniumisopropoxide, titaniummethacrylatetriisopropoxide, titaniummethacryloxyethylacetoacetatetriisopropoxide, titanium n-propoxide, zirconium n-butoxide, zirconium t-butoxide, zirconiumdimethacrylatedibutoxide, zirconium ethoxide, zirconiumisopropoxide, zirconiummethacrylate, zirconium methacryloxyethylacetoacetatetri-n-butoxide, zirconyldimethacrylate, methyltrimethoxysilane, methyltriethoxysilane, tetraethoxysilane (tetraethylorthosilicate; TEOS), and tetramethoxysilane, singularly or in combination.

The curing accelerator included in the sol solution is preferably a curing accelerator containing organic acid, and allows a condensation reaction at a comparatively low temperature and thus contributes to the application of a roll-to-roll technique. The curing accelerator may include anhydride, carboxylic acid, and mixtures thereof. Suitable examples of the anhydride include acetic anhydride, acrylic anhydride, cyclic anhydride, hexahydrophthalic anhydride, methacrylic anhydride, propionic anhydride, and mixtures thereof. Available carboxylic acid substances include acetic acid, acrylic acid, formic acid, fumaric acid, itaconic acid, maleic acid, methacrylic acid, propionic acid, methylenesuccinic acid, and mixtures thereof. These examples may be used singularly or in combination.

The inorganic acid may be an arbitrary inorganic acid able to catalyze a sol-gel hydrolysis reaction. Suitable inorganic acids include hydrochloric acid, nitric acid, sulfuric acid, hydrofluoric acid, and mixtures thereof.

The solvent may include methanol, ethanol, propanol, isopropanol, butanol, isobutanol, sec-butanol, tert-butanol, cyclohexanol, pentanol, octanol, decanol, di-n-butylether, ethyleneglycoldimethylether, propyleneglycoldimethylether, propyleneglycolmethylether, dipropyleneglycolmethylether, tripropyleneglycolmethylether, dipropyleneglycoldimethylether, tripropyleneglycoldimethylether, ethyleneglycolbutylether, diethyleneglycolbutylether, ethyleneglycoldibutylether, ethyleneglycolmethylether, diethyleneglycolethylether, diethyleneglycoldimethylether, ethyleneglycolethylether, ethyleneglycoldiethylether, ethyleneglycol, diethyleneglycol, triethyleneglycol, propyleneglycol, dipropyleneglycol, tripropyleneglycol, butyleneglycol, dibutyleneglycol, tributyleneglycol, tetrahydrofuran, dioxane, acetone, diacetone alcohol, methylethylketone, cyclohexanone, methylisobutylketone, ethylacetate, n-propylacetate, n-butylacetate, t-butylacetate, propyleneglycolmonomethyletheracetate, dipropyleneglycolmethyletheracetate, 1-methoxy-2-propanol, ethyl 3-ethoxypropionate, 2-propoxyethanol, and ethyleneglycolethyletheracetate, singularly or mixtures thereof.

A relative amount of the respective constituent ingredients of the sol solution for forming the organic-inorganic hybrid overcoating layer may be suitably controlled based on desired properties of the film, and the hybrid overcoating layer is preferably from 0.1 μm to 10 μm thick.

The inorganic rear layer, which is formed on the surface opposite to the inorganic gas barrier layer of the polymer substrate, i.e., a surface in contact with a display, includes oxide, nitride, carbide, oxynitride, oxycarbide, carbonitride, or oxycarbonitride containing at least one type of metal selected from the group consisting of Si, Al, In, Sn, Zn, Ti, Cu, Ce and Ta. Specifically, the inorganic gas barrier layer may include silicon oxide, silicon nitride, aluminum oxide or indium tin oxide (ITO).

To apply the optically transparent composite film to a display, the optically transparent composite film is adhered to a display device using an adhesive, and in this instance, because the polymer substrate of the optically transparent composite film has very low surface energy and a poor adhesive strength, bubbles are generated when attaching an adhesive, and there was a problem with limited application to a display device. Thus, the inventors recognized that it is necessary to increase the surface energy to improve the adhesive strength of the polymer substrate. However, the inventors identified that although the surface energy may dramatically increase after surface treatment when plasma treatment is used in the polymer substrate, because an interface between the polar surface and air is unstable, a polar group moves to a bulky side and the surface energy becomes low again, and accordingly, the present disclosure introduced the coating of an inorganic rear layer of a material having high surface energy rather than plasma treatment, to effectively increase the surface energy and increase a period of time during which the surface energy maintains.

Particularly, the inorganic rear layer preferably has a thickness from 1 nm to 50 nm, more preferably from 5 nm to 20 nm, or from 10 nm to 15 nm. When forming the inorganic rear layer to increase the adhesion with a display, a thick layer out of the thickness range may reduce the procedural efficiency and cause problems with crack generation or deterioration in optical characteristics, so it is preferred to form the inorganic rear layer at a small thickness within the above range as opposed to the inorganic gas barrier layer. That is, the inorganic rear layer according to the present disclosure somewhat differs in its objective from the inorganic gas barrier layer. However, because a surface energy increase effect is insignificant when the thickness is less than the above range, it is preferred to satisfy the thickness range.

After forming the inorganic layer, the surface energy on the rear surface of the gas barrier coating layer may be 50 mJ/m² or more, preferably 60 mJ/m² or more, or from 50 mJ/m² to 80 mJ/m², preferably from 60 mJ/m² to 70 mJ/m², and when the above range is satisfied, the foregoing problems may be solved.

A method of manufacturing an optically transparent composite film for a display according to another aspect of the present disclosure includes preparing a polymer substrate containing a transparent thermoplastic base resin; forming a plasma surface treatment layer surface-modified by plasma treatment on one surface of the polymer substrate; forming an inorganic gas barrier layer on an upper surface of the plasma surface treatment layer; forming an organic-inorganic hybrid overcoating layer by applying a curable sol solution onto an upper surface of the inorganic gas barrier layer and curing the applied curable sol solution, the curable sol solution prepared by mixing a curable coating solution and a sol solution, the curable coating solution in which a (meth)acrylate monomer, a (meth)acrylate oligomer with an epoxy group having a weight average molecular weight of 500-10,000, and an initiator are dissolved in a solvent and silica particles are dispersed therein, the sol solution in which metal alkoxide, a curing accelerator, inorganic acid, and water are dissolved in a solvent; and forming an inorganic rear layer on a surface opposite to the gas barrier layer.

As described above, in the optically transparent composite film according to one aspect of the present disclosure, one surface of the polymer substrate is plasma-treated. In the plasma surface treatment, a degree of vacuum in a chamber is preferably from 0.1 mtorr to 500 mtorr, more preferably from 0.5 mtorr to 100 mtorr, more particularly preferably from 1 mtorr to 10 mtorr. The plasma power is from 0.1 W/cm² to 5 W/cm², preferably from 0.3 W/cm² to 3 W/cm², more preferably from 0.5 W/cm² to 1 W/cm², and the line speed is from 0.1 M/min to 5 M/min. When the degree of vacuum, the plasma power, and the line speed are out of the above ranges, the gas barrier effect and the adhesion with the inorganic barrier layer is not sufficiently obtained, and more specifically, when the degree of vacuum or the plasma power is too high or the line speed is too slow, the surface roughness of the substrate may rather increase during the process, and when the degree of vacuum or the plasma power is too low or the line speed is too high, the surface impurities may not be properly removed and modification may not be perfectly accomplished. Here, when determining the degree of vacuum, the plasma power, and the line speed, alteration or modification may be made within the range based on the type or condition of the substrate.

Also, the inorganic gas barrier layer is formed on the upper surface of the plasma surface treatment layer, and it is formed through deposition-coating by a physical or chemical method using oxide, nitride, carbide, oxynitride, oxycarbide, carbonitride, or oxycarbonitride containing at least one type of metal selected from the group consisting of Si, Al, In, Sn, Zn, Ti, Cu, Ce and Ta.

A method of forming the organic-inorganic hybrid overcoating layer on the formed inorganic gas barrier layer is not limited to a particular type, and may include a bar coating method, a spin coating method, a dip coating method, and a spray coating method.

In this instance, a process of forming the organic-inorganic hybrid coating layer by UV-curing or thermal-curing the applied curable sol solution is performed. At the step, there is no particular limitation on the UV curing if it causes a radical reaction by UV light sources, but a mercury or metal halide lamp may be used alone or together. For example, the UV curing may be performed with the energy between 160 mJ/cm² and 1600 mJ/cm² for a period of time between 1 second and several minutes, for example, 1 minute or less. Also, the thermal curing may be performed, for example, at the temperature between 100° C. and 200° C. for a period of time between 1 minute and several hours, for example, 1 hour or less, or from 2 minutes to 10 minutes.

The inorganic rear layer which is formed on the other surface of the polymer substrate is formed through deposition-coating by a physical or chemical method using oxide, nitride, carbide, oxynitride, oxycarbide, carbonitride, or oxycarbonitride containing at least one type of metal selected from the group consisting of Si, Al, In, Sn, Zn, Ti, Cu, Ce and Ta.

The optically transparent composite film for a display according to an exemplary embodiment may have an oxygen transmission rate of 0.2 cc/m²/day/atm or less, preferably 0.15 cc/m²/day/atm or less, more preferably 0.1 cc/m²/day/atm or less, a light transmittance of 90% or more, a vapor transmission rate of 0.01 g/m²/day or less, more preferably 0.008 g/m²/day or less, and adherence characteristics of 4B or more, preferably 5B or more.

Hereinafter, the present disclosure will be described in detail through examples to help understanding. The embodiments of the present disclosure, however, may take several other forms, and the scope of the present disclosure should not be construed as being limited to the following examples. The embodiments of the present disclosure are provided to more fully explain the present disclosure to those having ordinary knowledge in the art to which the present disclosure pertains.

### Example 1

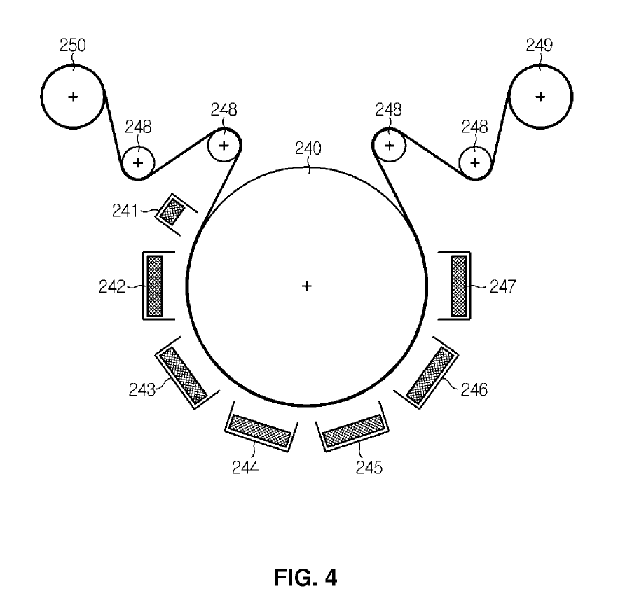

A 50 μm thick polyethylene terephthalate (PET) transparent film (Model name: SH34) made by SKC was used as a transparent plastic film which serves as a substrate. The plastic film was subjected to reaction at a rate of 2.7 M/min using a roll-to-roll sputter dual mode tool including six coating zones and a plasma treatment zone as shown in FIG. 4 by applying the power of 0.5 W/cm² to an electrode to generate a plasma while maintaining a degree of vacuum at 2 mtorr with oxygen gas being fed at 60 sccm (Standard Cubic Centimeter per Minute; 0° C., an amount at 1 atmospheric pressure) into the plasma treatment zone. Subsequently, silicon targets were mounted in a first coating zone and a second coating zone, and argon and nitrogen gas was each injected at a ratio of Ar:N₂=150:60, so a silicon nitride film was deposited on a plasma surface treatment layer with the power of 8.8 W/cm² at a rate of 1 M/min. In SEM observation, the silicon nitride film was found 30 nm thick.

To form a hybrid overcoating layer, a curable sol solution was prepared. First, 238.1 g of ethanol, 120.7 g of tetraethylorthosilicate (TEOS), 3.2 g of 36 wt % hydrochloric acid, and 41.1 g of water were agitated at 200 rpm for 1 hour at room temperature. Subsequently, 562.5 g of ethanol was added to produce a primary mixture.

Also, 0.55 g of hexahydrophthalic anhydride (HHPA) (Lonza Chemicals), 1.4 g of water, and 32 g of ethylalcohol were agitated at 250 rpm for 1 hour at room temperature, and after added to the primary mixture, were agitated at about 200 rpm for 4 hours at room temperature, followed by filtration through a 0.2 μm filter, to prepare a sol solution.

31 g of about 30 wt % colloidal silica solution (Nissan Chemicals, catalog no. IPA-ST) based on isopropyl alcohol as a solvent was ultrasonic-processed for 60 minutes at room temperature.

Also, 52.7 g of ethoxylated trimethylolpropanetriacrylate (Sartomer, catalog no. SR-454), 59.8 g of a bisphenol-A epoxyacrylateoligomer having a molecular weight of about 4,700 (Sartomer, catalog no. CN120), 2.84 g of a 1-hydroxy-cyclohexyl-phenyl-ketone photoinitiator (Siba, catalog no. Irgacure 184), and 1.17 g of a 2-methyl-1-[4-(methylthio)phenyl]-2-(4-morpholinyl)-1-propanone photolatent base (Siba, catalog no. 907) were mixed and agitated at about 200 rpm for 5 minutes. Subsequently, 110 g of the previously prepared ethyl acetate and 305 g of 1-methoxy-2-2propanol were added and agitated at 250 rpm for 30 minutes. The resulting mixture, the prepared silica solution, and 438 g of isopropanol were mixed again and agitated at 250 rpm for 1 hour at room temperature, to prepare a curable coating solution.

The sol solution was fed into the curable coating solution at 200 rpm while agitating for 1 hour, followed by filtration through a 1 μm filter, to prepare a curable sol solution for forming a hybrid overcoating layer.

Subsequently, the curable sol solution was coated on the inorganic gas barrier layer, dried at 100° C. for 30 seconds, and UV-cured with the energy of 1,000 mJ/cm². The formed hybrid overcoating layer was 2 μm thick.

Also, to improve adhesion with a display and impart additional barrier properties, an inorganic rear layer of silicon nitride was formed on the other surface of the polymer substrate with the inorganic gas barrier layer by the same method as the inorganic gas barrier layer. In this instance, the inorganic rear layer was 10 nm thick.

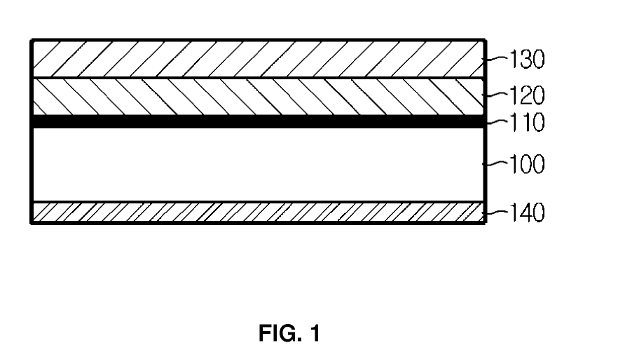

Referring to FIG. 1, on a polymer substrate 100, an inorganic gas barrier layer 110 and an overcoating layer 120 are stacked in a sequential order, and an inorganic rear layer 121 is formed on the other surface of the polymer substrate.

### Comparative Example 1

An optically transparent composite film for a display was manufactured by the same method as Example 1 except that plasma treatment and formation of an inorganic rear layer was not performed.

### Comparative Example 2

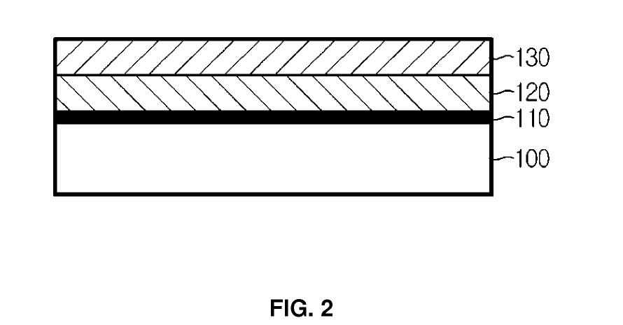

An optically transparent composite film for a display was manufactured by the same method as Example 1 except that an inorganic rear layer was not formed, and the optically transparent composite film is shown in cross section in FIG. 2.

### Comparative Example 3

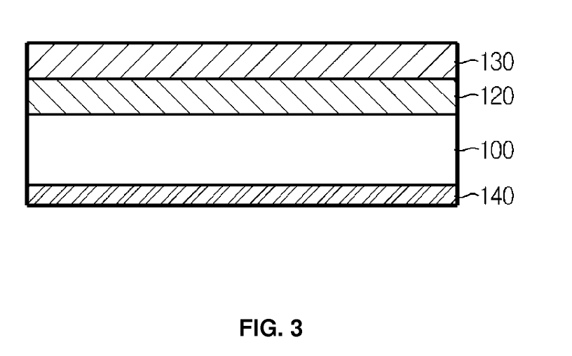

An optically transparent composite film for a display was manufactured by the same method as Example 1 except that plasma treatment was not performed, and the optically transparent composite film is shown in cross section in FIG. 3.

### Comparison of Plasma Treatment Effect

### Example 2

To compare the plasma effect, the surface roughness of a 50 μm thick cyclo olefin plastic (COP) film (made by ZEON CORPORATION) plasma-treated by the same method as Example 1 was measured.

### Comparative Example 4

To directly compare the plasma effect, the surface roughness of a 50 μm thick cyclo olefin plastic (COP) film (made by ZEON CORPORATION) was measured.

### EXPERIMENTAL EXAMPLE

For the optically transparent composite films of Example 1 and Comparative examples 1 through 3 manufactured by the above method, a vapor transmission rate, an oxygen transmission rate, a light transmittance, haze, scratch resistance, adhesion, and a rear surface energy of a polymer substrate were measured by the following evaluation method, and their results are shown in Table 1.

Also, to directly compare the plasma treatment effect, surface analysis results of Example 2 and Comparative example 4 are shown in Table 2.

1) Vapor transmission rate: measurement was made under 37.8° C./RH100% for 48 hours using Mocon PERMATRAN-W3/31.

2) Oxygen transmission rate: measurement was made under 35° C. RH0% using Mocon OX-TRAN 2/20.

3) Light transmittance: measurement was made according to ASTM D1003 using Minolta 3600D.

4) Haze: measurement was made according to ASTM D1003 using Nippon Denshoku NDH-5000.

5) Scratch resistance: scratch resistance was measured by 100-time reciprocation with a load of 300 g using steelwool#0000.

6) Adhesion: adhesion was evaluated according to ASTM D3359-02 based on an amount of coatings removed when removing a tape vertically after the coating surface was X-cut into 100 squares and the tape was closely attached thereto (5B: 0%, 4B: less than 5%, 3B: 5˜15%, 2B: 15˜35%, 1B: 35˜65%, 0B: 65% or more).

7) Surface energy: surface energy of the optically transparent composite film was measured using Future Digital Scientific Corp contact angle meter.

8) Surface roughness: surface roughness was measured using VEECO Dimension 3100 Atomic Force Microscope (AFM).

TABLE 1

| | Vapor | | | | | | Rear |
|---|---|---|---|---|---|---|---|
| | transmission | Oxygen | Light | | Scratch | | surface |
| | rate | transmission | transmittance | | resistance | | energy |
| | (g/m²/day) | rate (cc/m²/day/atm) | (550 nm, %) | Haze (%) | (%) | Adhesion | (mJ/m²) |
| Example 1 | 0.007 | 0.16 | >90 | <0.3 | <0.1 | 5B | 66.4 |
| Comparative | 0.084 | 0.68 | >90 | <0.3 | <0.1 | 5B | 41.23 |
| example 1 | | | | | | | |
| Comparative | 0.021 | 0.31 | >90 | <0.3 | <0.1 | 5B | 38.56 |
| example 2 | | | | | | | |
| Comparative | 0.078 | 0.56 | >90 | <0.3 | <0.1 | 5B | 64.11 |
| example 3 | | | | | | | |

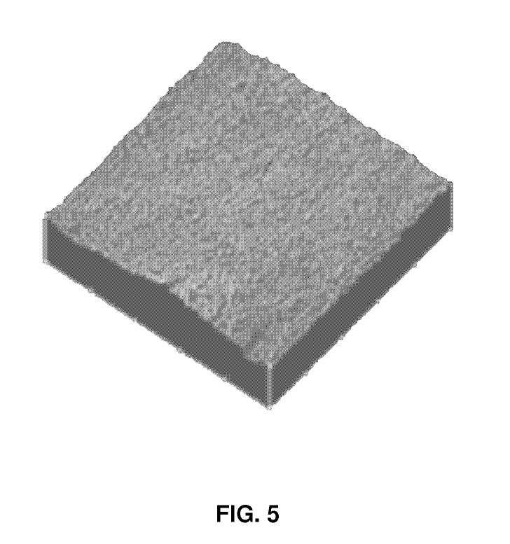

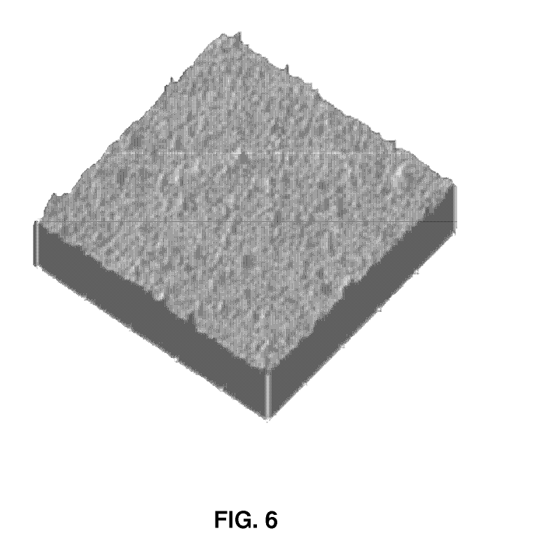

TABLE 2

| | Ra (nm) | Impurity size (nm) | Image |
|---|---|---|---|
| Example 2 | 0.1 | <2 | See FIG. 5 |
| Comparative example 4 | 0.9 | 20 | See FIG. 6 |

Through the above Table 1, Example 1 with the plasma treatment and the formed inorganic rear layer showed very high gas barrier properties with a vapor transmission rate of 0.006 g/m²/day and an oxygen transmission rate of 0.1 cc/m²/day/atm, and it is judged that sufficient adhesion with a device is expected from the rear surface energy of 64.59 mJ/m².

What is claimed is:

1. An optically transparent composite film for a display, comprising:
a polymer substrate containing a transparent thermoplastic base resin;
a plasma surface treatment layer formed on one surface of the polymer substrate and surface-modified by plasma treatment;
an inorganic gas barrier layer formed on an upper surface of the plasma surface treatment layer;
an organic-inorganic hybrid overcoating layer formed on an upper surface of the inorganic gas barrier layer, and including a resulting cured product of a curable sol solution, the curable sol solution being a mixture of a curable coating solution and a sol solution, the curable coating solution including a (meth)acrylate monomer, a (meth)acrylate oligomer with an epoxy group having a weight average molecular weight of 500-10,000, an initiator, silica particles, and a dispersant, the sol solution including metal alkoxide, a curing accelerator, inorganic acid, and a solvent; and
an inorganic rear layer formed on the other surface of the polymer substrate.

2. The optically transparent composite film for a display according to claim 1, wherein the optically transparent composite film for a display has an oxygen transmission rate less than or equal to 0.2 cc/m²/day/atm and a vapor transmission rate less than or equal to 0.01 g/m²/day.

3. The optically transparent composite film for a display according to claim 1, wherein the plasma surface treatment layer has surface roughness (Ra) less than or equal to 0.3 nm.

4. The optically transparent composite film for a display according to claim 1, wherein the plasma surface treatment layer is obtained by performing plasma treatment on one surface of the polymer substrate, and
the plasma treatment is performed by maintaining a degree of vacuum within a chamber in a range between 0.1 mtorr and 500 mtorr with reactive gas being fed into a plasma treatment zone, and applying plasma power from 0.1 W/cm² to 5 W/cm² and a line speed from 0.1 M/min to 5 M/min.

5. The optically transparent composite film for a display according to claim 1, wherein the inorganic rear layer includes oxide, nitride, carbide, oxynitride, oxycarbide, carbonitride, or oxycarbonitride containing at least one type of metal selected from the group consisting of Si, Al, In, Sn, Zn, Ti, Cu, Ce and Ta.

6. The optically transparent composite film for a display according to claim 1, wherein the inorganic rear layer has a thickness from 1 nm to 50 nm.

7. The optically transparent composite film for a display according to claim 1, wherein the inorganic rear layer has surface energy higher than or equal to 50 mJ/m².

8. The optically transparent composite film for a display according to claim 1, wherein the transparent thermoplastic base resin is any one selected from the group consisting of polyethersulfone, polycarbonate, polyimide, polyarylate, polyethyleneterephthalate, polyethylenenaphthalate, polyethyleneterephthalateglycol, polycyclohexylenedimethyleneterephthalateglycol, and cycloolefin copolymer, or mixtures thereof.

9. The optically transparent composite film for a display according to claim 1, wherein the inorganic gas barrier layer includes oxide, nitride, carbide, oxynitride, oxycarbide, carbonitride, or oxycarbonitride containing at least one type of metal selected from the group consisting of Si, Al, In, Sn, Zn, Ti, Cu, Ce and Ta.

10. The optically transparent composite film for a display according to claim 1, wherein the inorganic gas barrier layer has a thickness from 20 nm to 500 nm.

11. The optically transparent composite film for a display according to claim 1, wherein a weight ratio of the (meth)acrylate monomer, the (meth)acrylate oligomer with an epoxy group having a weight average molecular weight of 500-10,000, and the silica particles included in the curable coating solution is 1˜40:1˜40:1˜25.

12. The optically transparent composite film for a display according to claim 1, wherein the metal alkoxide included in the sol solution is any one selected from metal alkoxide represented by the following chemical formulas 1 through 3, or mixtures thereof:
R¹ₓM¹(OR²)₄₋ₓ [Chemical formula 1]
R¹_{y}M²(OR²)_{3-y} [Chemical formula 2]
R¹_{z}Nb(OR²)_{5-z} [Chemical formula 3]
where R¹ denotes any one selected from the group consisting of an alkyl group having 1 to 4 carbon atoms, a vinyl group, an allyl group, a (meth)acryloxy group, an epoxide group and an amino group, R² denotes an alkyl group having 1 to 4 carbon atoms, M¹ denotes a metal selected from the group consisting of Si, Ti, Zr, Ge and Sn, and M² denotes a metal selected from the group consisting of Al, In and Sb, in which x represents 0, 1, 2 or 3, y represents 0, 1 or 2, and z represents 0, 1, 2, 3 or 4.

13. The optically transparent composite film for a display according to claim 1, wherein the curing accelerator included in the sol solution is any one selected from acetic anhydride, acrylic anhydride, cyclic anhydride, hexahydrophthalic anhydride, methacrylic anhydride, propionic anhydride, acetic acid, acrylic acid, formic acid, fumaric acid, itaconic acid, maleic acid, methacrylic acid, propionic acid, and methylenesuccinic acid, or mixtures thereof.

14. The optically transparent composite film for a display according to claim 1, wherein the organic-inorganic hybrid overcoating layer has a thickness from 0.1 μm to 10 μm.

15. A method of manufacturing an optically transparent composite film for a display, the method comprising:
preparing a polymer substrate containing a transparent thermoplastic base resin;
forming a plasma surface treatment layer surface-modified by performing plasma treatment on one surface of the polymer substrate;
forming an inorganic gas barrier layer on an upper surface of the plasma surface treatment layer;
forming an organic-inorganic hybrid overcoating layer by applying a curable sol solution onto an upper surface of the inorganic gas barrier layer and curing the applied curable sol solution, the curable sol solution prepared by mixing a curable coating solution and a sol solution, the curable coating solution in which a (meth)acrylate monomer, a (meth)acrylate oligomer with an epoxy group having a weight average molecular weight of 500-10,000, and an initiator are dissolved in a dispersant and silica particles are dispersed therein, the sol solution in which metal alkoxide, a curing accelerator, inorganic acid, and water are dissolved in a solvent; and
forming an inorganic rear layer on a surface opposite to the gas barrier layer.

16. The method of manufacturing an optically transparent composite film for a display according to claim 15, wherein the forming of the plasma surface treatment layer comprises maintaining a degree of vacuum within a chamber in a range between 0.1 mtorr and 500 mtorr with reactive gas being fed into a plasma treatment zone, and applying plasma power from 0.1 W/cm² to 5 W/cm² and a line speed from 0.1 M/min to 5 M/min.

17. A flexible display product comprising an optically transparent composite film for a display according to claim 1.
